(19) United States
(12) Patent Application Publication
(10) Pub. No.: US 2004/0158702 A1
(43) Pub. Date: Aug. 12, 2004

(54) Redundancy architecture of computer system using a plurality of BIOS programs

(75) Inventor: Haruhisa Tasaki, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/609,610

(22) Filed: Jul. 1, 2003

(30) Foreign Application Priority Data
Jul. 3, 2002 (JP) 2002-194261

(51) Int. Cl. G06F 15/177

(52) U.S. Cl. 713/2

(57) ABSTRACT

A computer system is composed of a CPU, a timer started in response to a power-on and a reset of the computer system, a storage device storing a plurality of BIOS programs, a selector circuit selecting one of the plurality of the BIOS programs, and a system reset circuit. Each of the BIOS programs includes a boot block, and a core block which includes instructions for restarting the timer. The CPU firstly executes the BIOS program selected by the selector circuit. When the timer times out, the selector circuit selects another one of the BIOS programs. The CPU executes the newly selected BIOS program. In the meantime, the system reset circuit developing a system reset signal in response to the timer timing out for allowing the computer system to be reset.

### BACKGROUND OF THE INVENTION

1. Field of the Invention

The present invention is related, in general to a computer system, in particular to booting a computer system with a set of BIOS (basic input Output System) programs.

2. Description of the Related Art

A BIOS is a basic set of instructions which boots a computer system, and provides an interface to the underlying hardware for the operating system. A typical BIOS includes a core block and a boot block. The core block initializes a computer system and loads an operating system into a main memory. The boot block is started immediately after the power-on and reset of the system, and executes a cyclic redundancy check on the core block and allows the core block to control the system when no error is found in the core block.

The corruption of the BIOS disables the computer system for normally being booted. Therefore, a computer system often includes a plurality of BIOS programs to achieve a redundant architecture in case of an accident.

Japanese unexamined patent application No. Jp-A Heisei 11-316687 and the corresponding U.S. Pat. No. 6,167,532 disclose a computer system which includes system memory, containing BIOS instructions, having multiple bootable partitions and the ability to enable Automatic System Recovery (ASR) protection during an early phase of the boot process. Early ASR allows errors occurring during the boot process to be handled by established ASR techniques. Multiple BIOS partitions allow a user to upgrade and/or test new system routines without the potential of losing the functionality of their existing system.

Japanese unexamined patent application No. Jp-A 2000-148467 discloses a computer system which includes a BIOS ROM storing therein a pair of BIOS programs, and an address switching circuit. When an error is detected in one of the BIOS programs, the address switching circuit selects another of the BIOS programs. The selected BIOS program allows the system to be booted. Japanese unexamined patent application No. Jp-A 2000-163268 discloses another computer system similar to the aforementioned computer system.

Japanese unexamined patent application No. Jp-A 2001-92689 and the corresponding U.S. Pat. No. 6,560,726 disclose a method and system for integrated support for solving problems with personal computer systems, which comprises monitoring operating system functionality to determine if a computer system failure exists, to identify the computer system failure and to provide a solution of the computer system failure. A robust user interface, including a simple-to-use user button interface, supports single touch user input to indicate a computer system problem or question. Watchdog timers compare the time of hardware and operating system functionality, such as boot sequence operation, against predetermined time periods to determine whether or not a computer failure exists. A computer system failure is determined if a watchdog timer expires upon completion of a predetermined time period without being cleared. A hardware problem is identified on initial boot if the watchdog timer is not cleared by an operating system service routine. An operating system hang-up is determined if a watchdog timer is not cleared by an application run in association with the operating system. If a computer failure is detected, a service mode is initiated with a service mode operating system to allow in-depth analysis and problem resolution. Service mode operation is also monitored to detect problems.

Japanese unexamined patent application No. Jp-A Heisei 6-35737 discloses an automatic system recovery method to distinguish a system error resulting from an error in software from that from an electric disturbance such as noise, and to recover of the system error. When the system is reset in response to a watchdog timer expiring, a software block executed just before the reset is executed again by referring to a software history. If the system is reset again, the software block is prohibited from being executed, and the software error is recorded in an error history file. When the system is not reset during re-executing the software block, an error generation due to a disturbance is recorded in the error history file.

### SUMMARY OF THE INVENTION

An object of the present invention is to provide a system and method which enables a computer system to be normally booted even if a boot block of a BIOS system is corrupted.

In an aspect of the present invention, a computer system is composed of a CPU, a timer started in response to a power-on and a reset of the computer system, a storage device storing a plurality of BIOS programs, a selector circuit selecting one of the plurality of the BIOS programs, and a system reset circuit. Each of the BIOS programs includes a boot block, and a core block which includes instructions for restarting the timer. The CPU firstly executes the BIOS program selected by the selector circuit. When the timer times out, the selector circuit selects another one of the BIOS programs. The CPU executes the newly selected BIOS program. In the meantime, the system reset circuit developing a system reset signal in response to the timer timing out for allowing the computer system to be reset.

In response to the computer system being powered on, the CPU sequentially executes the boot and core blocks of the firstly selected BIOS program. When the boot block of the firstly selected BIOS program is corrupted, the booting process does not proceed to the core block, and thus the timer is not restarted. This causes the timer to time out. Similarly, the corruption of the core block of the firstly selected BIOS program causes the timer to time out. The time out of the timer allows the selector circuit to select another BIOS program to be executed by the CPU, and causes the computer system to be reset. In response to the reset of the system, the computer system is normally booted by using the newly selected BIOS program.

### BRIEF DESCRIPTION OF THE DRAWINGS

FIG. 1 is a schematic block diagram of a PC server in an embodiment;

FIG. 2 is a flowchart describing a booting process of the PC server;

FIG. 3 is a schematic block diagram of a PC server in an alternative embodiment; and

FIG. 4 is a schematic block diagram of a PC server in another alternative embodiment.

### DESCRIPTION OF THE PREFERRED EMBODIMENTS

Preferred embodiments of the present invention are described below in detail with reference to the attached drawings.

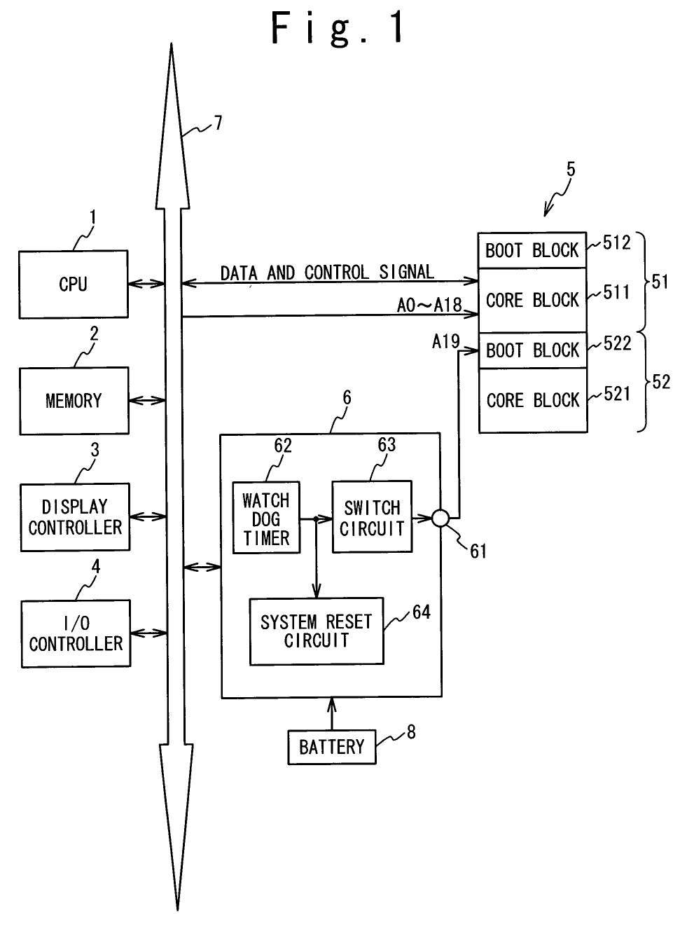

In one embodiment, as shown in FIG. 1, a PC server includes a CPU 1, a memory 2 including a RAM and a ROM, a display controller 3, an I/O controller 4, a flash ROM 5, a chipset 6, a bus 7 providing connections among these elements, and a backup battery 8.

The flash ROM 5 is a rewritable non-volatile memory storing a pair of BIOS programs 51, and 52, which have the same size. The BIOS program 51 includes a core block 511 and a boot block 512, and the BIOS program 52 includes a core block 521 and a boot block 522.

The core blocks 511 and 521, which are identical or different versions, allow the server system to be initialized, and to boot an operation system (OS). In addition, the core blocks 511 and 512 have a function to periodically restart a watchdog timer 62, which is described later in detail. The period of restarting the watchdog timer 62 is shorter than the timeout duration of the watchdog timer 62.

The boot blocks 512 and 522, which are identical or different versions, are executed immediately after the power-on and reset of the PC server to check the core blocks 511 and 512 with a CRC (cyclic redundancy checksum). The boot blocks 512 and 522 allow the core blocks 521 and 522 to start controlling the system when not finding any error in the core blocks 511 and 512.

In this embodiment, the size of each BIOS program is 512 kByte. The flash ROM 5 provides an address space of 1 Mbytes, and the core blocks 512 is stored in the upper address space of 512 kByte, while the core blocks 522 is stored in the lower address space of 512 kByte. The flash ROM 5 is addressed by an address including address bits A0 to A19. The address bit A19 is the most significant bit of the address. Setting the address bit A19 to logic 1 allows the BIOS program 51 to be accessed, while setting the address bit A19 to logic 0 allows the BIOS program 51 to be accessed. The address bits A0 to A18 are received from the CPU 1 through the bus 7, while the address bit A19 is received from an output 61 of the chipset 6.

The chipset 6 is a peripheral LSI which provides connections among the CPU 1, the memory 2, and a PCI (peripheral component interconnect) bus to achieve an access control, and also functions as an interface of a USB (universal serial bus).

In this embodiment, the chip set 6 includes the aforementioned watchdog timer 62, a selector circuit 63, and a system reset circuit 64.

The watchdog timer 62 is a restartable hardware timer which is started in response to the power-on and reset of the PC server. The watchdog timer 62 outputs a timeout signal to the selector circuit 63 and the system reset circuit 64 if not restarted in the predetermined timeout duration T. The timeout duration T is longer than duration between the power-on (or the reset) of the PC server system and the first restart of the watchdog timer 62 caused by the core blocks 511 and 521, when the PC server system is normally started.

The selector circuit 63 contains therein the addresses bit A19, and develops it on the output 61. The selector circuit 63 inverts the addresses bit A19 in response to receiving the timeout signal from the watchdog timer 62. The selector circuit 63 inverts the address bit A19 to logic 0 in response to receiving the timeout signal when the address bit A19 is originally set to logic 1, while inverting the address bit A19 to logic 1 in response to receiving the timeout signal when the address bit A19 is originally set to logic 0. The selector circuit 63 may include a flipflop which inverts the output thereof in response to the input of the timeout signal.

The system reset circuit 64 develops a system reset signal in response to receiving the timeout signal from the watchdog timer 62 to allow the PC server to be reset.

The backup battery 8 supplies power to the chipset 6 to avoid the value of the address bit A19 being erased in case of the electric power failure.

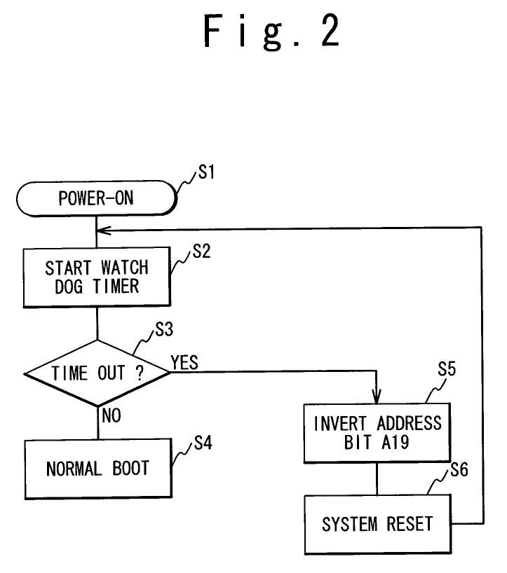

FIG. 2 is a flowchart illustrating the process of starting the PC server. The address bit A19, which is developed on the output 61 of the selector circuit 63, is initially set to logic 1 to activate the BIOS program 51. The power-on of the PC server at Step S1 allows the watchdog timer 62 to start at Step S2.

In the meantime, the CPU 1 accesses the boot block 512 of the BIOS program 51 in response to the address bit A19 being set to logic 1. The CPU 1 executes the process defined in the boot block 512, and then executes the core block 511.

When both of the execution of both of the boot block 512 and the core block 511 is successfully completed, the timeout of the watchdog timer 62 does not occur because the watchdog timer 62 is repeatedly restarted by the core block 511 at Step S3. This allows the PC server to be started by a normal procedure at Step S4.

On the other hand, the corruption of the boot block 512 causes the watchdog timer 62 to time out at Step S3, because the corrupted boot block 512 is unable to start the core block 511, which periodically restarts the watchdog timer 62 to avoid the timeout thereof.

The corruption of the core block 511 also causes the watchdog timer 62 to time out at Step S3, because the corrupted core block 511 is unable to restart the watchdog timer 62.

The timeout of the watchdog timer 62 causes the timer 62 to develop the timeout signal.

In response to receiving the timeout signal, the selector circuit 63 inverts the address bit A19 from logic 1 to logic 0 and develops the inverted address bit A19 on the output 61 at Step S5.

The system reset circuit 64 then develops the system reset signal at Step S6 to reset the PC server in response to the timeout signal.

The same goes for the reset of the PC server except for that the address bit A19 is set to logic 0. The reset of the PC server being reset causes the watchdog timer 62 to be started at Step S2. In response to the address bit A19 being set to logic 0, the CPU 1 accesses the boot block 522 in place of the boot block 512. The CPU 1 then executes the process defined in the boot block 522, and then executes the core block 521. When the execution of both of the boot block 522 and the core block 521 is successfully completed, the timeout of the watchdog timer 62 does not occur, because the watchdog timer 62 is repeatedly restarted by the core block 521 at Step S3. This allows the PC server to be started by a normal procedure at Step S4.

The corrupted core block and boot block of the BIOS program 51 and 52 may be recovered using the unbroken core block and boot block stored in the flash ROM 5. The rewritable flash ROM 5 allows the recovery of the corrupted core block and boot block without replacing a corrupted ROM with a normal ROM.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

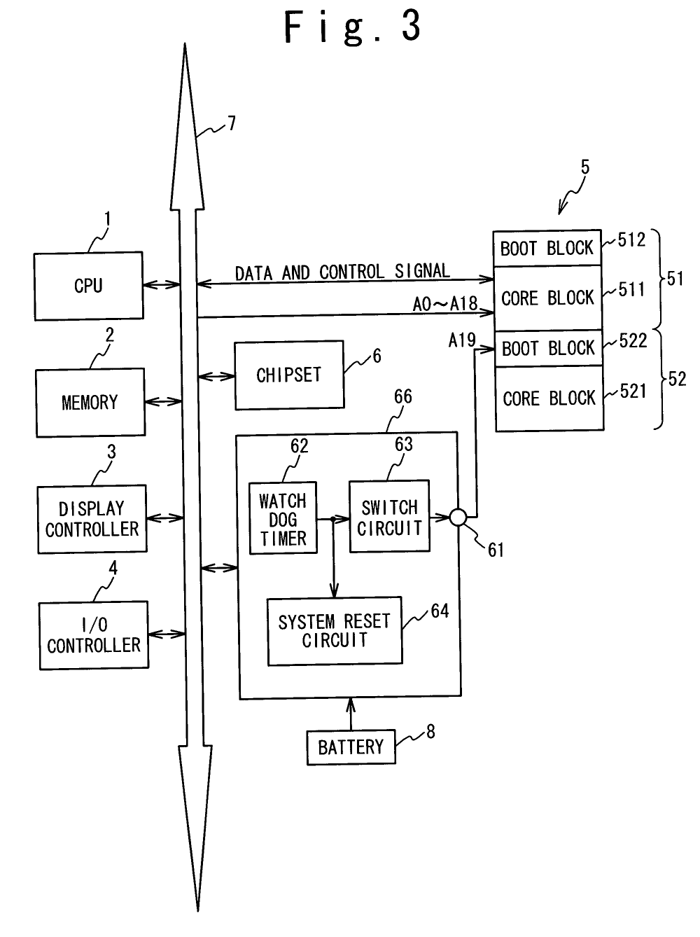

Especially, it should be noted that the watchdog timer 62, the selector circuit 63, and the system reset circuit 64 may be disposed in a BMC (baseboard management controller) 66 provided for the PC server as shown in FIG. 3. In this case, the address bit A19 is outputted through one of the outputs of the BMC 66. Alternatively, the watchdog timer 62, the selector circuit 63, and the system reset circuit 64 may be disposed in other peripheral devices.

Also, one skilled in the art would appreciate that the present invention may be applied to other computer systems, such as personal computers and workstations.

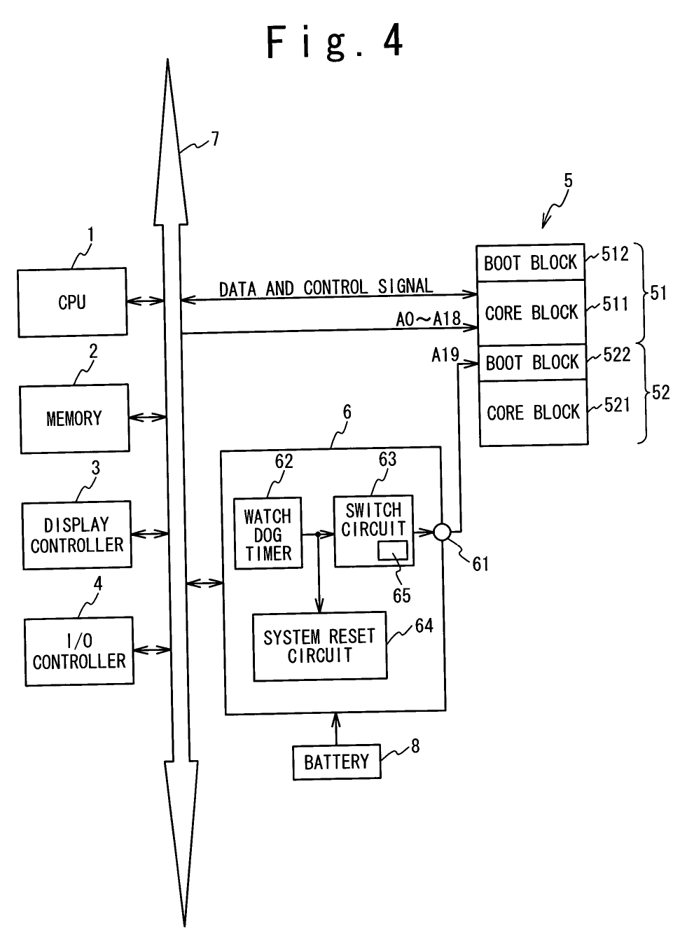

As shown in FIG. 4, the state of the selector circuit 63, that is, the value of the address bit A19 may be stored in a non-volatile memory 65 disposed in the selector circuit 63. The non-volatile memory 65 may include an EEPROM.

Three or more BIOS programs may be stored in the flash ROM 5. In this case, the BIOS programs are sequentially switched, each time the watchdog timer 62 is timed out.

The BIOS programs 51 and 52 may be stored in a mask ROM or an EEPROM in place of the flash ROM 5.

What is claimed is:

1. A computer system comprising:
a CPU;
a timer started in response to a power-on and a reset of said computer system;
a storage device storing a plurality of BIOS programs, each of which includes:
a boot block, and
a core block which includes instructions for restarting said timer;
a selector circuit selecting one of said plurality of said BIOS programs, wherein said CPU executes said selected BIOS program, and said selector circuit selects another one of said plurality of said BIOS programs in response to said timer timing out to allow said CPU to execute said another one of said plurality of said BIOS programs; and
a system reset circuit developing a system reset signal in response to for allowing said computer system to be reset.

2. The computer system according to claim 1, further comprising a battery, wherein said selector circuit includes a volatile memory unit storing BIOS selection data indicative of which BIOS program is selected, said battery provides power for said memory unit.

3. The computer system according to claim 2, wherein said storage device is addressed by an address, and said BIOS selection data is a most significant bit of said address.

4. The computer system according to claim 1, wherein said wherein said selector circuit includes a non-volatile memory unit storing BIOS selection data indicative of which BIOS program is selected.

5. The computer system according to claim 4, wherein said storage device is addressed by an address, and said BIOS selection data is a most significant bit of said address.

6. The computer system according to claim 1, wherein said timer includes a watchdog timer.

7. The computer system according to claim 1, wherein said storage device includes a flash ROM.

8. The computer system according to claim 1, further comprising:
a bus connected to said CPU; and
a chipset connected to said CPU through said bus, wherein said timer, said selector circuit, and said system reset circuit are disposed in said chipset.

9. The computer system according to claim 1, further comprising:
a bus connected to said CPU; and
a BMC connected to said CPU through said bus, wherein said timer, said selector circuit, and said system reset circuit are disposed in said BMC.

10. A method for booting a computer system comprising:
starting a timer in response to a power-on of said computer system;
executing a boot block of a first BIOS program selected from among a plurality of BIOS programs, said boot block including first instructions for executing a core block of said BIOS program, said core block including second instructions for restarting said timer;
selecting a second BIOS program in place of said first BIOS program from among said plurality of BIOS programs in response to said timer timing out;
resetting said computer system in response to said timer timing out;
executing a boot block of said second BIOS program in response to said computer system being reset.
